(19) United States
(12) Patent Application Publication
(10) Pub. No.: US 2004/0084820 A1
(43) Pub. Date: May 6, 2004

(54) Shock absorber for vehicles

(75) Inventors: Rentaro Kato, Kasugai-shi (JP); Takahiro Aoi, Komaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKAI RUBBER INDUSTRIES, LTD., Komaki-shi (JP)

(21) Appl. No.: 10/694,762

(22) Filed: Oct. 29, 2003

(30) Foreign Application Priority Data
Oct. 30, 2002 (JP) 2002-316580

(51) Int. Cl. F16F 7/00

(52) U.S. Cl. 267/141

(57) ABSTRACT

A vehicle shock absorber includes a housing, and a shock-absorbing member. The housing has at least one hollow formed therein, is formed of a rigid material, and is fixed to a bone structural member of vehicles. The shock-energy absorbing member is disposed in the hollow of the housing at least, and is formed of a super plastic polymer material. The super plastic polymer material exhibits a tensile breaking elongation of 200% or more, a yield strength of 20 MPa or more with respect to a predetermined strain, and a tensile elastic modulus of 400 MPa or more.

### BACKGROUND OF THE INVENTION

1. Field of the Invention

The present invention relates to a vehicle shock absorber which can be used suitably in bone structural members, such as vehicle frames, bodies and door impact beams, for example.

2. Description of the Related Art

A variety of shock absorbers or suspensions have been employed conventionally in vehicle frames or panel boards in order to protect human bodies by absorbing shocks upon colliding. For example, bumper beams or crush boxes are installed to the front and rear of vehicle frames in order to absorb shock energies when vehicles collide. The shock absorbers are usually formed of metal such as iron and aluminum alloys, and are hollow-structured so as to have a hollow therein in order to avoid the weight enlargement.

Moreover, the following techniques have been employed in order to upgrade the shock-energy absorbing ability of the shock absorbers: adding reinforcement plates, and increasing the thickness of metallic plates making the shock absorbers. However, when reinforcement plates are added or the thickness of metallic plates is increased, it is inevitable to result in sharply enlarging the weight. Hence, the assignee of the present invention proposed a novel shock absorber in Japanese Unexamined Patent Publication (KOKAI) No. 2001-132,787. The shock absorber comprises a metallic housing having a hollow therein, and a foamed elastic body disposed in the hollow of the housing and composed of polyurethane foam or epoxy resin foam having predetermined characteristics. In accordance with the shock absorber, it is possible to provide a high shock-energy absorbing ability while avoiding the sharp enlargement of the weight.

Meanwhile, a new plastic material called “ASUWAN” has been developed recently as set forth in the article titled “First in the World, Development of New Material by Professor Inoue et al. of Yamagata University” in the web version of “YAMAGATA SHINBUN” newspaper's morning edition issued on Apr. 1, 2002. The homepage can be located at http://polyweb.yz.yamagata-u.ac.jp/topics/yamashinkiji3.html. Note that the present inventors searched the homepage on Sep. 10, 2002. The new plastic material is produced by mixing flakes, which are made by pulverizing used PET (i.e., polyethylene terephthalate) bottles, with plastic and rubber, and reacting the resulting mixture chemically. The new plastic material has the characteristic of plastics, for example, it can be formed (or melt formed) by heating. In addition, the new plastic material exhibits remarkable shock resistance. It is reported that the new plastic material can be put into practical use in automobile outer panels.

The shock absorber disclosed in Japanese Unexamined Patent Publication (KOKAI) No. 2001-132,787 might be insufficient slightly in view of the characteristics. While the present inventors were trying out various new materials to overcome the drawback, they found that the new plastic material reported in the web article had been developed. Although the shock resistance is an ability of materials to endure shocks without breaking or being destroyed, it is not necessarily possible to say that it is identical with the shock-energy absorbing characteristic. In other words, it is necessary to verify the other parameters in addition to tenacity or toughness (e.g., a high tensile breaking elongation) whether materials exhibit a high shock-energy absorbing ability. From this perspective, it had not been apparent whether the new plastic material would exhibit a high shock-energy absorbing ability.

### SUMMARY OF THE INVENTION

The present invention has been developed in view of the aforementioned circumstances. It is therefore an object of the present invention to provide a shock absorber for vehicles, shock absorber which can exhibit a remarkably upgraded shock-energy absorbing ability while inhibiting the weight from enlarging sharply.

The inventors of the present invention studied wholeheartedly the new plastic material inside out while taking notice of the shock resistance of the new plastic material. As a result, they found out that the new plastic material exhibits a high shock-energy absorbing ability. Thus, they completed the present invention.

A vehicle shock absorber according to the present invention can achieve the aforementioned object, and comprises:

a housing having at least one hollow formed therein, formed of a rigid material, and fixed to a bone structural member of vehicles; and

a shock-energy absorbing member disposed in the hollow of the housing at least, and formed of a super plastic polymer material exhibiting a tensile breaking elongation of 200% or more, a yield strength of 20 MPa or more with respect to a predetermined strain and a tensile elastic modulus of 400 MPa or more.

Note that the characteristics of the super plastic polymer material are defined as follows. The tensile breaking elongation set forth herein designates a tensile breaking elongation defined in Japanese Industrial Standard (hereinafter abbreviated to as “JIS”) K7113 (equivalent to ISO 527 (e.g., ISO 527-1, ISO 527-2, ISO 527-3, ISO 527-4 and ISO 527-5)). The yield strength with respect to a predetermined strain designates a yield strength with respect to a predetermined strain defined in JIS K7113. Specifically, the yield strength with respect to a predetermined value is a tensile stress when the tensile breaking elongation is 200%, for example. The yield strength with respect to a predetermined stress will be hereinafter simply referred to as a “specific-strain yield strength”. The tensile elastic modulus is a tensile elastic modulus defined in JIS K7113.

The shock-energy absorbing member of the present vehicle shock absorber is formed of the super plastic material exhibiting a tensile breaking elongation of 200% or more, a specific-strain yield strength of 20 MPa or more and a tensile elastic modulus of 400 MPa or more. Accordingly, the shock-energy absorbing member exhibits not only tenacity or toughness but also tensile strength and tensile elastic force with respect to high load. Thus, when vehicles collide to input shocks into the present vehicle shock absorber, the shock-energy absorbing member deforms plastically together with the housing to absorb shock energies. In this instance, the shock-energy absorbing member can deform plastically to a sufficiently great magnitude. Accordingly, the shock-energy absorbing member can show an extremely high shock-energy absorbing characteristic which has not been available conventionally. Consequently, the shock-energy absorbing member absorbs shock energies in a remarkably enhanced amount. As a result, it is possible to relatively reduce the amount of shock energies to be absorbed by the housing. Therefore, not only it is possible to achieve ample weight saving by reducing the thickness of the housing, but also it is possible to securely give the present vehicle shock absorber a high shock-energy absorbing ability.

Therefore, it is possible to remarkably upgrade the shock-energy absorbing ability of the present vehicle shock absorber while avoiding the sharp enlargement of the weight.

The housing of the present vehicle shock absorber can be formed of metallic materials such as ferrous alloys and aluminum alloys, for example. As for the ferrous alloys, it is possible to employ general ferrous alloys such as carbon steel, alloy steel, cast steel and cast iron, for instance. As for the aluminum alloys, it is possible to employ general aluminum alloys such as Al—Mn alloys, Al—Si Alloys, Al—Mg alloys and Al—Cu—Mn alloys, for example. In view of the strength, corrosion resistance, specific gravity and processability, it is suitable to employ Al—Mg—Si aluminum alloys such as A6063 (as per JIS) and A6061 (as per JIS), for instance. Note that, when the housing is formed as a cylinder, it is possible to use formed workpieces which are formed by simple methods such as extruding, for example.

Moreover, the housing of the present vehicle shock absorber has at least one hollow in which the shock-energy absorbing member is disposed. The hollow of the housing cannot necessarily be formed in an enclosed manner. The housing can have a plurality of hollows by disposing at least one partition wall therein. When such a partition wall is disposed, the rigidity of the housing is enhanced so that it is advantageous to further reduce the weight of the housing. In order to achieve the weight reduction of the housing more securely, the thickness of the housing can preferably be 2 mm or less, further preferably be from 0.5 to 2.0 mm.

In addition, the housing is usually formed independently of vehicle bone structural members, and is fixed to vehicle bone structural members. Depending on cases, it is possible to make the entirety or a part of the housing out of vehicle bone structural members. With such an arrangement, it is possible to obviate or simplify the installation operation of the present vehicle shock absorber provided with the thus formed housing.

The shock-energy absorbing member of the present vehicle shock absorber is made by forming the super plastic polymer material, for example, the new plastic material called “ASUWAN,” as predetermined shapes. It is possible to arbitrarily design the shapes of the shock-energy absorbing member in accordance with the shapes of the housing. Note that the super plastic polymer material can be produced by mixing flakes of polyethylene terephthalate, a major component, with resin and rubber and reacting them chemically.

As described above, the super plastic polymer material exhibits such characteristics that a tensile breaking elongation is 200% or more, a specific-strain yield strength is 20 MPa or more, and a tensile elastic modulus is 400 MPa or more. When the tensile breaking elongation is less than 200%, it is not possible to give the resulting shock-energy absorbing member tenacity or toughness satisfactorily. The tensile breaking elongation can preferably be 250% or more. Moreover, when the specific-strain yield strength is less than 20 MPa, it is not possible to give the resulting shock-energy absorbing member tensile strength with respect to high load satisfactorily. The specific-strain yield strength can preferably be 25 MPa or more. In addition, when the tensile elastic modulus is less than 400MPa, it is not possible to have the resulting shock-energy absorbing member exhibit satisfactory tensile elastic force with respect to high load. The tensile elastic modulus can preferably be 500 MPa or more.

The shock-energy absorbing member is disposed in the hollow of the housing at least. The shock-energy absorbing member cannot necessarily be spread entirely in the hollow, but can be disposed only at portions where shocks are input into the housing. Moreover, when the housing has a plurality of hollows, the shock-absorbing member can be disposed in at least one of the hollows.

The shock-energy absorbing member can preferably have a surface at least, the surface facing a shock input direction and disposed in a manner contacting closely with an inner surface of the housing. With such an arrangement, it is possible not only to enhance the rigidity of the housing but also to show the shock-energy absorbing characteristic of the shock-energy absorbing member most effectively when shocks are input into the present vehicle shock absorber. Note that it is possible to assemble the shock-energy absorbing member with the housing in a manner compressed by the housing in a shock input direction, because the shock-energy absorbing member is formed independently of the housing.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure:

FIG. 1 is a cross-sectional view of a vehicle shock absorber according to Example No. 1 of the present invention;

FIG. 2 is a graph for illustrating the compression characteristic of test pieces in Test No. 2;

FIG. 3 is a graph for illustrating the compression characteristic of Example No. 1 as well as Comparative Example Nos. 1 and 2 in Test No. 3;

FIG. 4 is a front view partly in cross-section for illustrating how a vehicle shock absorber according to Example No.2 of the present invention is installed to an impact beam;

FIG. 5 is a cross-sectional view of the present vehicle shock absorber according to Example No. 2 taken in the direction perpendicular to the axial direction, e.g., in the direction of the arrows “5”-“5” of FIG. 4;

FIG. 6 is an explanatory diagram for illustrating the steps of installing the present vehicle shock absorber according to Example No. 2;

FIG. 7 is a cross-sectional view of a vehicle shock absorber according to Example No. 3 of the present invention;

FIG. 8 is a cross-sectional view how the present vehicle shock absorber according to Example No. 3 is installed; and

FIG. 9 is a plan view for illustrating a test piece which was used in a tensile test for examining a super plastic polymer material employed in the examples of the present invention.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

The preferred embodiments according to the present invention will be hereinafter described with reference to specific examples.

### EXAMPLE NO. 1

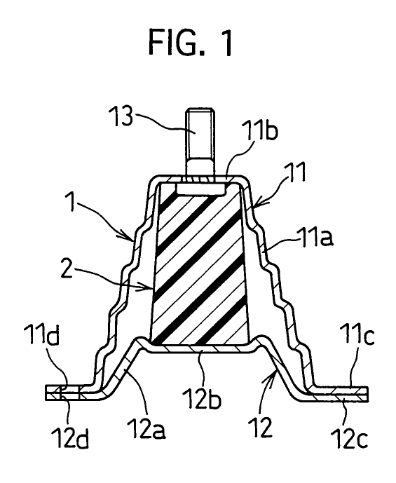

FIG. 1 is a cross-sectional view of a vehicle shock absorber according to Example No. 1 of the present invention.

The present vehicle shock absorber according to Example No. 1 is a crush box. The crush box holds a bumper stay with which a vehicle is equipped, and is installed to the vehicle so as to absorb shock energies upon colliding. As illustrated in FIG. 1, the crush box comprises a housing 1, and a shock-energy absorbing member 2. The housing 1 has a hollow therein. The shock-energy absorbing member 2 is disposed in the hollow of the housing 1, and is composed of a super plastic polymer material.

The housing 1 comprises a first member 11, and a second member 12. The first member 11 is formed as a longer cylinder shape one of whose opposite ends is bottomed. The second member 12 is formed as a shorter cylinder shape one of whose opposite ends is bottomed, and which is fixed to an opening end of the first member 11 so as to cover and close the opening of the first member 11. The first member 11 and second 12 are formed by pressing a thin ferrous metallic plate whose thickness is about 1.2 mm in order to save the weight sufficiently. The first member 11 has a cylinder 11a which is formed as steps, and has diameters which increase step by step from the bottom 11b to the opening. The opening end of the cylinder 11a is provided with a ring-shaped flange 11c which extends outward radially. The bottom 11c of the first member 11 is pierced at the center to form a round hole. An installation bolt 13 is fitted into the round hole so as to protrude the shank outside, and is fastened to the bottom 11b of the first member 11 at the head.

The second member 12 has a cylinder 12a which is formed as a reversed taper enlarging radially from the bottom 12b to the opening gradually. The opening end of the cylinder 12a is provided with a ring-shaped flange 12c which extends outward radially. The flange 12c of the second member 12 overlaps with the flange 11c of the first member 11, and is fastened to the flange 11c by welding. Thus, the cylinder 12a and bottom 12b of the second member 12 which go into the first member 11 cover and close the opening of the first member 11. As a result, an enclosed hollow is formed in the first member 11. Moreover, a plurality of installation holes 11d, 12d into which not-shown installation bolts are fitted are formed in the flanges 11c, 12c of the first and second members 11, 12, respectively.

The shock-energy absorbing member 2 is formed as a cylinder shape by melt molding a super plastic polymer material. As described above, the super plastic polymer material exhibits such characteristics that a tensile breaking elongation is 200% or more, a specific-strain yield strength is 20 MPa or more and a tensile elastic modulus is 400 MPa or more. For example, the super plastic polymer comprises a new plastic material which is called “ASUWAN” and produced by MIRAI KASEI Co., Ltd. Note that the shock-energy absorbing member 2 is lightweight because it has a density of 1.2 g/cm³.

The shock-energy absorbing member 2 is disposed in the hollow of the housing 1 so as to press the bottom 11b of the first member 11 and the bottom 12b of the second member 12 with the opposite axial ends. In other words, the bottom 11c of the first member 11 and the bottom 12c of the second member 12 compress the shock-energy absorbing member 2 slightly in the axial direction to dispose it in the hollow of the housing 1. Thus, not only the housing 1 is enhanced in terms of the rigidity in the axial direction, but also the shock-energy absorbing member 2 can show the shock-energy absorbing characteristic most effectively with respect to shocks to be input in the axial direction.

The thus constructed crush box according to Example No. 1 is installed to a front-side member of a vehicle by fastening the flanges 11c, 12c of the housing 1 to the front-side member with not-shown bolts. Moreover, a bumper stay is installed to the crush box by the installation bolt 13 so as to hold the crush box.

When the vehicle equipped with the crush box collides in driving and shocks are input into the crush box through the bumper stay, the shock-energy absorbing member 2 deforms plastically together with the housing 1 to absorb the shock energies. In this instance, the shock-energy absorbing member 2 shows an extremely high shock-energy absorbing characteristic which has not been available conventionally, because it can deform plastically sufficiently greatly. Accordingly, it is possible to relatively reduce the amount of shock energies which are absorbed by the housing 1, because the amount of shock energies which are absorbed by the shock-energy absorbing member 2 is enhanced. Consequently, not only it is possible to save the weight of the crush box adequately by reducing the thickness of the housing 1, but also to give the crush box a high shock-energy absorbing ability securely.

As described so far, in the present crush box according to Example No. 1, the shock-energy absorbing member 2 having a high shock-energy absorbing ability is disposed in the hollow of the housing 1. As a result, it is possible to upgrade the shock-energy absorbing ability of the crush box remarkably while avoiding the sharp increment of the weight.

Moreover, the shock-energy absorbing member 2 is disposed in the hollow of the housing 1 in such a state that it is compressed by the bottom 11b of the first member 11 and the bottom 12b of the second member 12 slightly in the axial direction. Therefore, not only it is possible to enhance the rigidity of the housing 1 in the axial direction, but also it is possible to have the shock-energy absorbing member 2 show the high shock-energy absorbing characteristic most effectively with respect to shocks to be input in the axial direction.

### Test No. 1

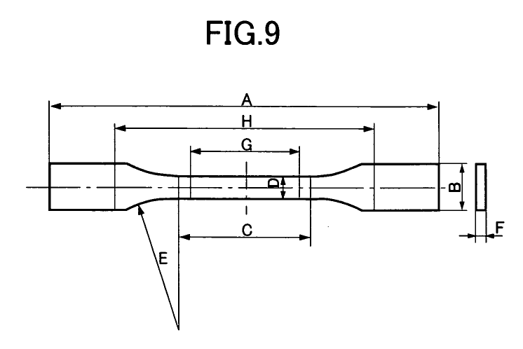

A first test was carried out in order to examine the shock-energy absorbing member 2 (or the super plastic polymer material) for the tensile breaking elongation in %, the specific-strain yield strength in MPa and the tensile elastic modulus in MPa. The test was carried out in accordance with JIS K7113, testing method for tensile properties of plastics, by using the #1 test piece set forth therein. The test pieces were molded with the super plastic polymer material (or were cut out of a plate formed of the super plastic polymer material). The test pieces had a shape as illustrated in FIG. 9. Specifically, the test piece had an overall length “A” of 175 mm, a width “B” of 20±0.5 mm at the opposite ends, a length “C” of 60±0.5 mm at the parallel portion, a width “D” of 10±0.5 mm at the parallel portion, a minimum radius “E” of 60 mm at the shoulders, a thickness “F” of 3 mm, a distance “G” of 50±0.5 mm between the datum lines, and distance “H” of 115±0.5 mm between the holding jigs. Note that the test pieces were pulled with the holding jigs at a rate of 50 mm/min.±10%. Moreover, in this instance, the other test pieces were prepared with epoxy resin foam and polyurethane foam as comparative examples, and were tested in the same manner. The epoxy resin foam was produced by Henkel Co., Ltd., and is set forth in SAE Paper No. 99002. The polyurethane foam was the same one as used in Example No. 1 disclosed in Japanese Unexamined Patent Publication (KOKAI) No.2001-132,787.

Note that the specific-strain yield strength was measured as a tensile stress with respect to a predetermined strain, for example, when the tensile breaking elongation was 200%. Moreover, the specific-strain yield strength of the epoxy resin foam could not be measured, because the test pieces formed of the same broke immediately after starting the test. Table 1 below summarizes the results of Test No. 1.

In addition, datum values necessary for assessing the three characteristics affecting the shock-energy absorbing ability were set at 200% for the tensile breaking elongation, 20 MPa for the specific-strain yield strength, and 400 MPa for the tensile elastic modulus.

TABLE 1

| | | Super | | |
|---|---|---|---|---|
| | | Plastic | Epoxy | |
| | Datum | Polymer | Resin | Polyurethane |
| | Value | Material | Foam | Foam |
| Tensile Breaking | 200 | 310 | 60 | 300 |
| Elongation (%) | | | | |
| Specific-strain | 20 | 31 | Not | 16.6 |
| Yield Strength (MPa) | | | Measurable | |
| Tensile Elastic Modulus | 400 | 650 | 690 | 281 |
| (MPa) | | | | |

It is understood from Table 1 that, although the epoxy resin foam exhibited a tensile elastic modulus only which went far beyond the datum value, it exhibited a tensile breaking elongation which was far below the datum value and lacked a specific-strain yield strength. Moreover, although the polyurethane foam exhibited a tensile breaking elongation only which went far beyond the datum value, it was slightly poor in terms of the specific-strain yield strength and tensile elastic modulus. On the contrary, it is apparent that the super plastic polymer material exhibited characteristics which exceeded the datum values remarkably in all of the tensile breaking elongation, specific-strain yield strength and tensile elastic modulus. From the results, it is appreciated that the super plastic polymer material has an extremely favorable shock-energy absorbing ability.

### Test No. 2

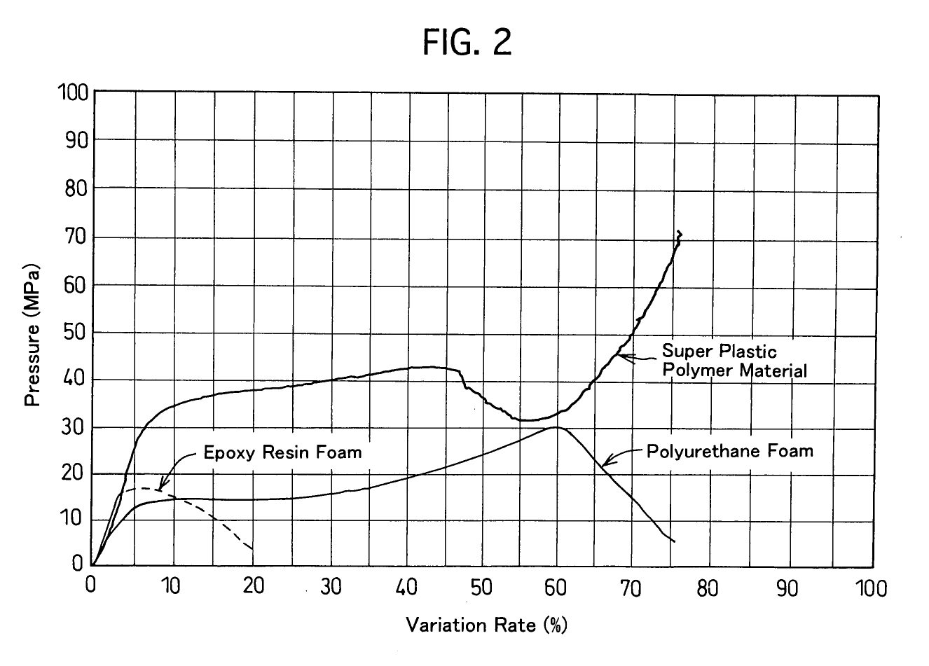

A second test was carried out in order to examine the compression characteristic of the super plastic polymer material, epoxy resin foam and polyurethane foam. In this test, test pieces were used which were formed as a cylinder shape of 29 mm in diameter and 49 mm in length. The respective test pieces were placed on a testing bench vertically, and were compressed on the top-end surface at a compression rate of 10 mm/min. with a pressing jig. Note that the pressing jig had a pressing surface whose area was wider than that of the top-end surface of the test pieces sufficiently. The test pieces were examined for the relationship between the pressure in MPa and the variation rate in %, and provided the results as illustrated in FIG. 2.

In FIG. 2, note that the amount of shock energies absorbed by the respective test pieces is equal to the area of regions which are enclosed by the respective characteristic curves and the horizontal axis specifying the variation rate. Moreover, the tensile elastic modulus of the respective test pieces is specified by the initial rising inclination angle of the respective characteristic curves. Note that the larger the tensile elastic modulus is, the larger the initial rising inclination angle is.

As can be seen from FIG. 2, the epoxy resin foam exhibited a compression-variation rate characteristic curve whose initial rising inclination angle was large, because it exhibited a large tensile elongation modulus. However, the compression-variation rate characteristic curve was a convex-shaped curve whose pressure peak was at around 18 MPa. Additionally, the maximum variation rate, the end point of the compression-variation rate characteristic curve was 20%. Thus, it is understood that the amount of shock energies absorbed by the epoxy resin foam was extremely less.

Moreover, the polyurethane foam exhibited a compression-variation rate characteristic curve whose initial rising inclination angle was small, because it exhibited a tensile elongation modulus smaller than that of the epoxy resin foam by half or less. However, the compression-variation rate characteristic curve rose gently when the variation rate was in the range of from 5 to 60%, had a peak at a variation rate of 60% and a pressure of 30 MPa, and declined down to the end point at which the variation rate was 76%. Thus, it is understood that the amount of shock energies absorbed by the polyurethane foam was greater than the amount of shock energies absorbed by the epoxy resin foam markedly. Specifically, the polyurethane foam absorbed shock energies as much as 6 to 7 times of shock energies absorbed by the epoxy resin foam approximately.

On the other hand, the super plastic polymer material exhibited a compression-variation rate characteristic curve whose initial rising inclination angle was large, because it exhibited a tensile elongation modulus as large as that of the epoxy resin foam substantially. In addition, the initial rising continued even after the pressure went beyond 30 MPa. The compression-variation rate characteristic curve rose gently up to a pressure of 42 MPa when the variation rate was in the range of from 7 to 45%, declined temporarily when the variation rate went beyond 45%, and thereafter rose sharply from around a variation rate of 60% up to the end point at which the variation rate was 76%. Note that the compression-variation rate characteristic curve of the super plastic polymer material was always placed on the upper side above the compression-variation rate characteristic curve of the polyurethane foam. Thus, the super plastic polymer material absorbed shock energies in a remarkably great amount as much as 2.5 times of shock energies absorbed by the polyurethane foam approximately.

### Test No. 3

A third test was carried out in order to verify that the present shock absorber according to Example No. 1 had a good shock-energy absorbing ability. As Comparative Example No. 1, a shock absorber was prepared which comprised the housing 1 of the Example No. 1 only and was free from the shock-energy absorbing member 2. Moreover, as Comparative Example No. 2, another shock absorber was prepared which was different from the shock absorber according to Example No. 1 only in that the shock-absorbing member 2 was formed of the same polyurethane foam as used in Test No. 1 instead of the super plastic polymer material.

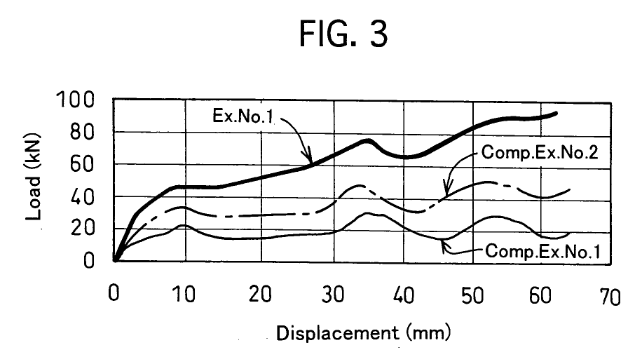

In order to examine the compression characteristic of the shock absorbers according to Example No. 1 as well as Comparative Example Nos. 1 and 2, compression loads were applied to the shock absorbers according to Example No. 1 as well as Comparative Example Nos. 1 and 2 in the axial direction, thereby measuring the displacements in mm and the loads in kN for the displacements. The shock absorbers according to Example No. 1 as well as Comparative Example Nos. 1 and 2 provided the results as illustrated in FIG. 3. In FIG. 3, note that the amount of shock energies absorbed by the respective shock absorbers is equal to the area of regions which are enclosed by the respective characteristic curves and the horizontal axis specifying the displacement. Moreover, the tensile elastic modulus of the respective shock absorbers is specified by the initial rising inclination angle of the respective characteristic curves. Note that the larger the tensile elastic modulus is, the larger the initial rising inclination angle is.

As can be seen from FIG. 3, Comparative Example No. 1 exhibited a compression-variation characteristic curve whose initial rising inclination angle was small, because it exhibited a small tensile elongation modulus. Moreover, the compression-variation characteristic curve did not rise beyond a variation of 10 mm, and rose up to a load of 20 kN only. In addition, even when the variation enlarged, the compression-variation characteristic curve leveled off in a load range of from 15 to 30 kN after it rose up, though it fluctuated. Thus, it is understood that the amount of shock energies absorbed by Comparative Example No. 1 was less.

Moreover, Comparative Example No. 2 exhibited a compression-variation characteristic curve whose initial rising inclination angle was larger than that of Comparative Example No. 1, because it exhibited a tensile elongation modulus larger than that of Comparative Example No. 1. The compression-variation characteristic curve rose up to around a load of 30 kN when Comparative Example No. 2 exhibited a variation of 10 mm. In addition, even when the variation enlarged, the compression-variation characteristic curve leveled off in a load range of from 30 to 50 kN after it rose up, though it fluctuated. Thus, it is understood that the amount of shock energies absorbed by Comparative Example No. 2 was larger than that of Comparative Example No. 1 by about 2 times.

On the other hand, Example No. 1 exhibited a compression-variation characteristic curve whose initial rising inclination angle was much larger than that of Comparative Example No.2, because it exhibited a tensile elongation modulus much larger than that of Comparative Example No. 2. The compression-variation characteristic curve rose up to around a load of 45 kN when Example No. 1 exhibited a variation of 8 mm. In addition, as the variation enlarged, the compression-variation characteristic curve started rising gently again even after it rose up, though it declined temporarily at around when Example No. 1 exhibited a variation of 40 mm. Note that the peak load, approximately 90 kN, appeared when the variation was maximum. Thus, it is understood that the amount of shock energies absorbed by Example No. 1 was larger than that of Comparative Example No. 2 by about 2 times, and was extremely great.

The facts indicate that it is possible to more sharply upgrade the shock-energy absorbing ability when shock-energy absorbing members formed of the super plastic polymer material are accommodated in the hollow of housings as in the present shock absorber according to Example No. 1 than when shock-energy absorbing members formed of the epoxy resin foam or polyurethane foam are accommodated in the hollow of housings.

### EXAMPLE NO. 2

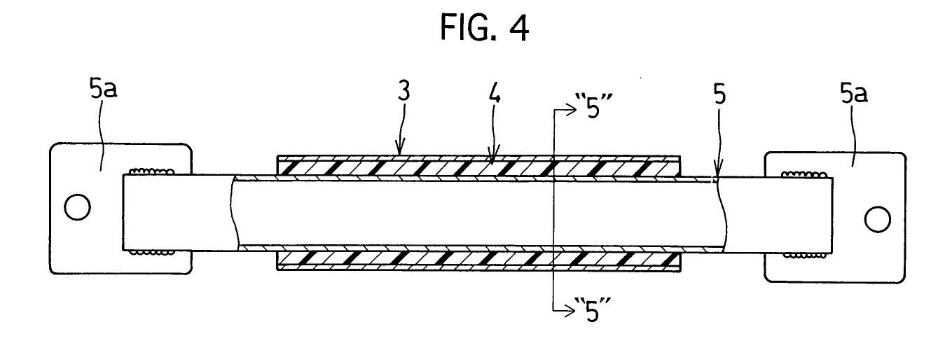

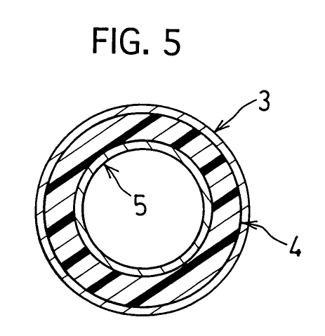

FIG. 4 is a front view partly in cross-section for illustrating how a vehicle shock absorber according to Example No. 2 of the present invention is installed to an impact beam. FIG. 5 is a cross-sectional view of the present vehicle shock absorber taken in the direction perpendicular to the axial direction, e.g., in the direction of the arrows “5”-“5” of FIG. 4.

The present vehicle shock absorber according to Example No. 2 is equipped with vehicle doors, and is then installed to impact beams which absorb shock energies upon colliding. As illustrated in FIGS. 4 and 5, the present vehicle shock absorber comprises a cylinder-shaped housing 3, and a cylinder-shaped shock-energy absorbing member 4. The housing 3 is fastened outside an impact beam coaxially. The shock-absorbing member 4 is disposed in a hollow formed between the housing 3 and the impact beam 5, and is composed of a super plastic polymer material. Note that the impact beam 5 is herein formed by cutting a ferrous metallic pipe whose thickness is about 1.6 mm to a predetermined length, and is fixed to a bone structural member of door panels by way of brackets 5a, 5a which are fastened by welding onto the outer periphery of the opposite ends.

The housing 3 is formed by cutting a ferrous metallic pipe whose thickness is about 2.3 mm to a predetermined length shorter than the length of the impact beam 5. The housing 3 has an inside diameter greater than the outside diameter of the impact beam 5, and is fitted around the impact beam 5 coaxially so that it is disposed outside the impact beam 5 by a predetermined distance away therefrom. Thus, a cylinder-shaped space (or hollow) in which the shock-energy absorbing member 4 is disposed is formed between the inner peripheral surface of the housing 3 and the outer peripheral surface of the impact beam 5. In other words, the housing 3 and the impact beam 5 form the space (or hollow) in which the shock-energy absorbing member 4 is disposed, and the impact beam 5 is utilized as a part of the housing 3. Note that the housing 3 is reduced diametrically by subjecting the outer periphery to drawing after it is fitted outside the impact beam 5 coaxially.

The shock-energy absorbing member 4 is formed as a pipe shape by melt forming the same super plastic polymer material as used in Example No. 1. Similarly to the shock-energy absorbing member 2 in Example No. 1, the shock-energy absorbing member 4 exhibits such characteristics that a tensile breaking elongation is 200% or more, a specific-strain yield strength is 20 MPa or more, and a tensile elastic modulus is 400 MPa or more. The shock-energy absorbing member 4 is disposed in the space (or hollow) formed between the inner peripheral surface of the housing 3 and the outer peripheral surface of the impact beam 5 so that it is compressed diametrically. Thus, not only the housing 3 is enhanced in terms of the rigidity in the diametric direction, but also the shock-energy absorbing member 4 can show the shock-energy absorbing characteristic most effectively with respect to shocks to be input in the diametric direction.

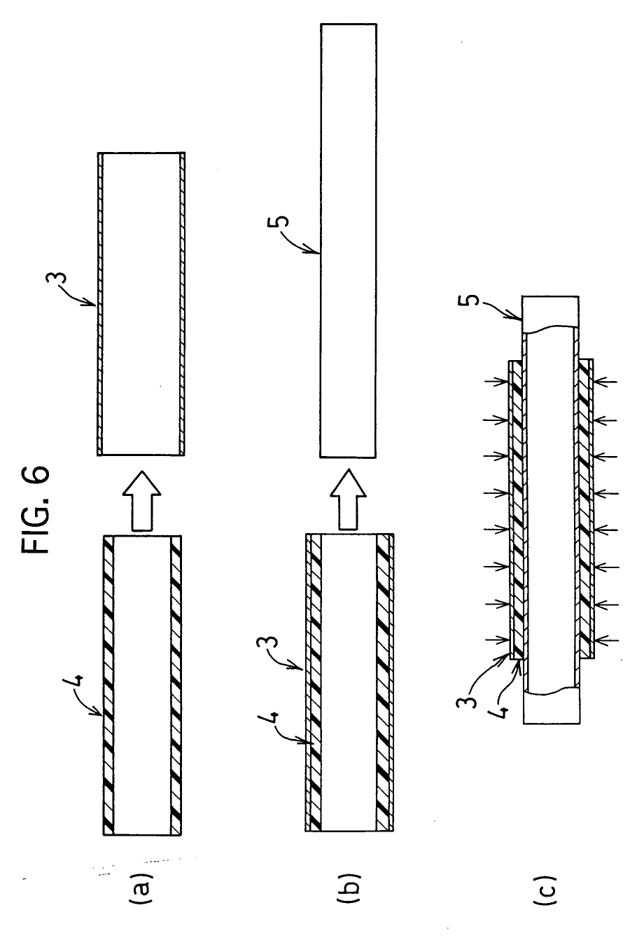

The present shock absorber according to Example No. 2 is installed to the impact beam 5 in the following manner. Firstly, as illustrated in FIG. 6(a), the shock-absorbing member 4 formed as a pipe with a predetermined size is assembled with the housing 3 formed as a pipe with a predetermined size by fitting the shock-absorbing member 4 into the housing 3. Thus, the shock absorber is manufactured in which the housing 3 and the shock-absorbing member 4 are integrated. Secondly, as illustrated in FIG. 6(b), the shock absorber is fitted outside the impact beam 5 coaxially, and is disposed at a predetermined position.

Thirdly, as illustrated in FIG. 6(c), the housing 3 is reduced diametrically by about 3 to 5% by subjecting the outer periphery to drawing. Accordingly, the shock-energy absorbing member 4 disposed between the housing 3 and the impact beam 5 is compressed as the housing 3 is compressed diametrically. Thus, the shock absorber with the compressed shock-energy absorbing member 5 is fixed to the impact beam 5. Note that the brackets 5a, 5a are fastened onto the outer periphery of the opposite ends of the impact beam 5 after the shock absorber is thus installed to the impact beam 5.

When vehicles with the thus installed shock absorber are collided on the side surface and shocks are input into the impact beam 5 from the outside, the housing 3 and shock-energy absorbing member 4 of the shock absorber deform plastically together with the impact beam 5 to absorb the shock energies. In this instance, the shock-energy absorbing member 4 shows an extremely high shock-energy absorbing characteristic, because it can deform plastically sufficiently greatly. Accordingly, it is possible to sharply enhance the shock-energy absorbing action resulting from the entire impact beam 5, because the amount of shock energies which are absorbed by the shock-energy absorbing member 4 is enhanced remarkably. Consequently, not only it is possible to save the weight of the impact beam 5 adequately by reducing the thickness of the impact beam 5, but also to give the impact beam 5 a high shock-energy absorbing ability securely.

As described above, the present shock absorber according to Example No. 2 can produce advantages, such as enabling the impact beam 5 to show an upgraded shock-energy absorbing ability while inhibiting the weight of the impact beam 5 from enlarging sharply, in the same manner as Example No. 1.

Note that, although the present shock absorber according to Example No. 2 is installed outside the impact beam 5 coaxially, it is possible to install the shock absorber inside the impact beam 5 coaxially depending on cases.

### EXAMPLE NO. 3

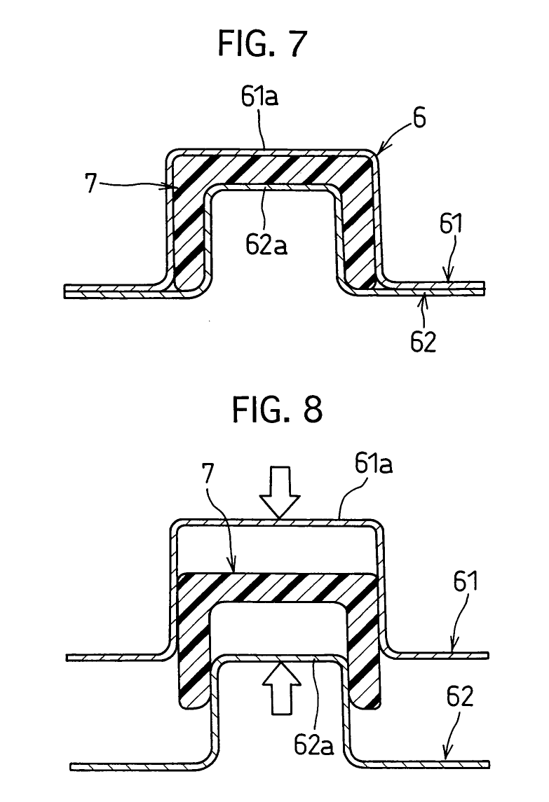

FIG. 7 is a cross-sectional view for illustrating a vehicle shock absorber according to Example No. 3 of the present invention.

The present shock absorber according to Example No. 3 is installed to a side sill which is disposed on a body floor of vehicles to extend in the width-wise direction of vehicles. The shock absorber utilizes a side sill, a bone structural member of vehicles, as the housing, one of the component parts. As illustrated in FIG. 7, the shock absorber comprises a housing 6, and a shock-energy absorbing member 7. The housing 6 comprises an outer member 61 and an inner member 62 which make a side sill, and has a hollow therein. The shock-absorbing member 6 is disposed in the hollow of the housing 6, and is composed of a super plastic polymer material.

Specifically, the housing 6 comprises the outer member 61, and inner member 62 which are composed of a continuously-long thin ferrous metallic plate, respectively. At the middle in the width-wise direction of the outer member 61, there is formed a major protrusion 61a which has an inverted letter “U”-shaped cross-section and extends in the longitudinal direction or the length-wise direction of the outer member 61. Moreover, at the middle in the width-wise direction of the inner member 62, there is formed a minor protrusion 62a which has an inverted letter “U”-shaped cross-section, extends in the longitudinal direction or the length-wise direction of the outer member 61, and is smaller than the major protrusion 61a. In particular, the minor protrusion 62a of the inner member 62 is formed so that it has a smaller width and a lower protrusion height than those of the major protrusion 61a of the outer member 61. The outer member 61 and the inner member 62 are overlapped and fastened by welding at the opposite ends so that the minor protrusion 62a comes into the major protrusion 61a. Thus, between the major protrusion 61a and the minor protrusion 62a, there is formed a hollow which has an inverted letter “U”-shaped cross-section and extends in the longitudinal direction or the length-wise direction of the housing 6.

The shock-energy absorbing member 7 is formed as a continuously-long letter “U”-shaped cross-section by thermally molding the same super plastic polymer material as used in Example No. 1. Similarly to the shock-energy absorbing member 2 in Example No. 1, the shock-energy absorbing member 7 exhibits such characteristics that a tensile breaking elongation is 200% or more, a specific-strain yield strength is 20 MPa or more, and a tensile elastic modulus is 400 MPa or more. The shock-energy absorbing member 7 is disposed in the hollow formed between the major protrusion 61a and minor protrusion 62a of the housing 6 so that it is compressed by the major protrusion 61a and minor protrusion 62a. Thus, not only the housing 6 is enhanced in terms of the rigidity with respect to shocks to be input from the outside of the housing 6, but also the shock-energy absorbing member 7 can show the shock-energy absorbing characteristic most effectively with respect to shocks to be input from the outside of the housing 6.

Moreover, the shock-energy absorbing member 7 is disposed in the hollow of the housing 6 as hereinafter described, for example. As illustrated in FIG. 8, the shock-energy absorbing member 7 is interposed between the major protrusion 61a of the outer member 61 and the minor protrusion 62a of the inner member 62. Then, the minor protrusion 62a is buried in or press-fitted into the major protrusion 61a.

As described above, in vehicles equipped with the side sill which is provided with the present shock absorber according to Example No. 3, it is possible to achieve body floors with high rigidity because the shock-energy absorbing member 7 which is disposed in the hollow of the housing 6, making the side sill, enhances the rigidity of body floors. Moreover, when such vehicles are collided and shocks are input into the side sill, the shock-energy absorbing member 7 deforms plastically sufficiently greatly so that it can show the high shock-energy absorbing characteristic. Accordingly, it is possible to achieve body floors with a high shock-energy absorbing ability.

Therefore, the present shock absorber according to Example No. 3 as well can produce advantages, such as enabling the housing 6 to show an upgraded shock-energy absorbing ability while inhibiting the weight of the housing 6 from enlarging sharply, in the same manner as Example No. 1.

Having now fully described the present invention, it will be apparent to one of ordinary skill in the art that many changes and modifications can be made thereto without departing from the spirit or scope of the present invention as set forth herein including the appended claims.

What is claimed is:

1. A shock absorber for vehicles, the shock absorber comprising:
a housing having at least one hollow formed therein, formed of a rigid material, and fixed to a bone structural member of vehicles; and
a shock-energy absorbing member disposed in the hollow of the housing at least, and formed of a super plastic polymer material exhibiting a tensile breaking elongation of 200% or more, a yield strength of 20 MPa or more with respect to a predetermined strain and a tensile elastic modulus of 400 MPa or more.

2. The shock absorber set forth in claim 1, wherein a part or the entirety of the housing is made of the bone structural member.

3. The shock absorber set forth in claim 1, wherein the super plastic polymer material is produced by mixing flakes of polyethylene terephthalate with resin and rubber and reacting them chemically.

4. The shock absorber set forth in claim 1, wherein the shock-energy absorbing member has a surface at least, the surface facing a shock input direction and disposed in a manner contacting closely with an inner surface of the housing.

5. The shock absorber set forth in claim 4, wherein the shock-energy absorbing member is compressed in a shock input direction.

6. The shock absorber set forth in claim 1, wherein the housing has a thickness of 2 mm or less.

7. The shock absorber set forth in claim 1, wherein the super plastic polymer material exhibits a tensile breaking elongation of 250% or more.

8. The shock absorber set forth in claim 1, wherein the super plastic polymer material exhibits a yield strength of 25 MPa or more with respect to a predetermined strain.

9. The shock absorber set forth in claim 1, wherein the super plastic polymer material exhibits a tensile elastic modulus of 500 MPa or more.

10. The shock absorber set forth in claim 1, wherein the super plastic polymer material absorbs shock energies in an amount of at least 2.5 times of an amount of shock energies absorbed by polyurethane foam.
